(19) United States
(12) Patent Application Publication
(10) Pub. No.: US 2012/0271440 A1
(43) Pub. Date: Oct. 25, 2012

(54) System For Acquiring and Processing Data Pertaining to a Shot of an Object, Such As A Puck or a Ball, On A Goal on a Playing Field

(75) Inventors: Thomas Lunner, Helsingborg (SE); Stephen Lunner, Vasteras (SE)

(73) Assignee: PERFORMANCE INTERNATIONAL RENNUL AB, Helsingborg (SE)

(21) Appl. No.: 13/090,069

(22) Filed: Apr. 19, 2011

(51) Int. Cl. G06F 19/00

(52) U.S. Cl. 700/91

(57) ABSTRACT

According to the present inventive concept there is provided a system for acquiring and processing data pertaining to a shot of an object, such as a puck or a ball, on a goal on a playing field, the goal being guarded by a goalkeeper, the system comprising: an acquisition device configured to acquire position data of the object during a time interval ΔT_{P} preceding the shot on goal, and a processing device configured to process the acquired position data of the object to estimate if an unobstructed path between the goalkeeper and the object is maintained throughout said time interval ΔT_{P}, and configured to register the shot on goal as a first type of shot at least on a condition that an unobstructed path between the goalkeeper and the object not was maintained throughout said time interval ΔT_{P}.

### FIELD OF THE INVENTION

The present invention relates to a system for acquiring and processing data pertaining to a shot of an object, such as a puck or a ball, on a goal on a playing field which goal is guarded by a goalkeeper.

### BACKGROUND OF THE INVENTION

The use of statistics is nowadays becoming more and more customary when analyzing and presenting information about games in various sports. The statistical information may assist sports commentators, spectators, viewers, coaches etc. in examining various parameters relating to the games. For example, one may be interested in shot statistics, scoring statistics, face-off statistics, the number of saves by the goalkeepers, ball/puck speeds and trajectories, tracking of players on the playing field etc.

Documents US2007135243A and U.S. Pat. No. 5,513,854 A disclose systems for tracking and analyzing the performance of a sport game. These systems may monitor basic aspects such as the movement of a ball of the game as well as the player performances. For example, the system according to US2007135243A may provide statistical information relating to the total distance the ball and/or the individual players have moved during a game. According to U.S. Pat. No. 5,513,854 A, the acquisition of sports-related information may be used either in real time or in a time-delayed fashion.

Sometimes, however, it is desirable to analyze certain scenarios of a sport game in a more detailed manner. Typically, these more complex analyses are carried out manually, e.g. by scrutinizing visual recordings of the game. Due to the fast-paced nature of a sport game, however, this method is often highly inaccurate and contains various sources of errors. Moreover, the method often relies on subjective assessments. However, such subjective elements may render the analysis less reliable. Thus, there is need for a system for analyzing a sport game in an objective, detailed and accurate manner.

### SUMMARY OF THE INVENTION

It is therefore an object of the present invention to provide a system allowing for a more accurate and reliable analysis of game situations, in particular those relating to shot on goals.

In accordance with the inventive concept, there is provided a system for acquiring and processing data pertaining to a shot of an object, such as a puck or a ball, on a goal on a playing field, where the goal is being guarded by a goalkeeper. The system comprises an acquisition device configured to acquire position data of the object during a time interval ΔT_{P} preceding the shot on goal. The system further comprises a processing device configured to process the acquired position data of the object to estimate if an unobstructed path between the goalkeeper and the object is maintained throughout the time interval ΔT_{P}, and configured to register the shot on goal as a first type of shot at least on a condition that an unobstructed path between the goalkeeper and the object not was maintained throughout said time interval ΔT_{P}.

The inventive concept enables automatic and objective classification of shots. More specifically it may be determined whether an unobstructed path between the goalkeeper and the object is maintained throughout the time interval ΔT_{P} preceding the shot on goal. ΔT_{P} may be a time interval immediately preceding the shot on goal. If an unobstructed path between the goalkeeper and the object is maintained throughout ΔT_{P} it may be considered likely that the goalkeeper has had the opportunity to spot and focus on the object and thus prepare for the shot. If so the shot may be estimated as a shot for which the line of sight between the goalkeeper and the object has been maintained during the time interval ΔT_{P} and may hence be considered as a comparably simple shot for the goalkeeper to save.

In contrast, if an unobstructed path between the goalkeeper and the object not was maintained throughout ΔT_{P} it may be considered likely that the goalkeeper not has had sufficient time to focus on the object and prepare for the shot. Such a shot may thus be considered as a comparably harder shot for the goalkeeper to save. More specifically, for such a type of shot, it may be assumed that the goalkeeper has had a relatively short time to focus on the object, thus making it harder for her/him to predict the trajectory of the shot. The system may automatically and objectively detect and register such a difficult type of shot.

The system may thus provide information regarding detailed aspects of a game, in particular regarding difficulty of a shot on goal. The shot classification may be utilized by e.g. a team coach, a spectator or a viewer of a game, or a sports commentator commenting on a game. For example, a team coach may utilize the shot classification as a coaching aid in order to improve the skills of the players, including the goalkeeper, comprised in the team. The skills of the players at an individual level as well as at a team level may be improved with regards to offensive as well as defensive game situations. For example, the players may gain a better scoring behavior and the goalkeepers may increase their saving skills. Moreover, a sports commentator may utilize the shot classification in order to provide the spectators and viewers of a game with more informed statistics.

According to one embodiment the playing field is a given area within which the sport game is performed. The playing field may be an ice hockey rink, a football field, or the like.

According to one embodiment the acquired position data represents the position of the object in relation to fixed reference point. The fixed reference point may be a point on the playing field such as a face-off position on the playing field or the goal guarded by the goalkeeper etc.

According to one embodiment the acquired position data represents the position of the object in relation to the goal keeper.

According to one embodiment the acquired position data represents the position of the object as a function of time.

According to one embodiment the acquisition device is further configured to acquire position data of the object during a time interval ΔT_{S} succeeding the shot on goal, and wherein the processing device is further configured to determine if an unobstructed path between the goalkeeper and the object is maintained during the time interval ΔT_{S}, and configured to register the shot on goal as the first type of shot at least on a condition that an unobstructed path between the goalkeeper and the object not was maintained throughout said time interval ΔT_{S}. ΔT_{S} may be a time interval immediately succeeding the shot on goal. This embodiment may be useful for determining e.g. if there is a player in between the goalkeeper and the object during its path towards the goal. This may disturb the goalkeeper and thus make it more difficult to save the shot. Accordingly, such a shot may be automatically detected and registered as the first type of shot.

According to one embodiment the processing device is further configured to process the acquired position data of the object during the time interval ΔT_{S} to determine a direction of the object during the time interval ΔT_{S}, and configured to register the shot on goal as the first type of shot at least on a condition that said direction of the object was changed sometime during said time interval ΔT_{S}. By way of example, the direction of the object may be changed as a result of the object rebounding from another player or a stick of a player, a deflection of the shot on goal by another player, etc. These are events that may make the shot more difficult for the goalkeeper to save. Accordingly, such a shot may automatically be detected and registered as the first type of shot. Alternatively or additionally, the processing device may be configured to determine a direction of the object during the time interval ΔT_{P}, and be configured to register the shot on goal as the first type of shot at least on a condition that the direction of the object was changed sometime during the time interval ΔT_{P}.

According to one embodiment, the processing device is further configured to process the acquired position data of the object to determine if the object sometime in the time interval ΔT_{P} has crossed a geometrical line extending longitudinally on the playing field in front of the goal, and wherein the processing device is configured to register the shot on goal as the first type of shot at least on a condition that the object has crossed the geometrical line during the time interval ΔT_{P}. This may be useful, for example, to determine if an object-carrying player performs a transversal movement towards a long side of the playing field requiring the goalkeeper to change the position of her/his head, which may result in a broken line of sight between the goalkeeper and the object or at least make it more difficult for the goalkeeper to prepare and get in position for the shot. Accordingly, such a situation may automatically be detected and the shot registered as the first type of shot.

According to one embodiment, the processing device is configured to register the shot on goal as a second type of shot on a condition that an unobstructed path between the goalkeeper and the object was maintained throughout the time interval ΔT_{P}. In accordance with the above, such a shot may be considered as a comparably easy shot for the goalkeeper to save.

According to one embodiment, the processing device is configured to register the shot on goal as a second type of shot on a condition that: an unobstructed path between the goalkeeper and the object was maintained throughout the time interval ΔT_{P}, and an unobstructed path between the goalkeeper and the object was maintained throughout the time interval ΔT_{S}. In accordance with the above, such a shot may be considered as a comparably easy shot for the goalkeeper to save. Optionally, the processing device may be configured to register the shot on goal as the second type of shot on the additional condition that the direction of the object was unchanged sometime during the time interval ΔT_{S}.

According to one embodiment, the processing device is configured to register the shot on goal as a second type of shot on a condition that an unobstructed path between the goalkeeper and the object was maintained throughout the time interval ΔT_{P} and the object has not crossed the geometrical line during said time interval ΔT_{P}. In accordance with the above, such a shot may be considered as a comparably easy shot for the goalkeeper to save.

According to one embodiment, the acquisition device is configured to acquire the position data of the object by receiving position data of the object. The acquisition device may for example receive a data set including coordinates of the object during the time interval ΔT_{P} and/or ΔT_{S}.

According to one embodiment, the acquisition device is configured to receive images representing the object during the time interval ΔT_{P} preceding the shot on goal. Optionally, the acquisition device may be further configured to receive images of the object on the playing field during the time interval ΔT_{S} succeeding the shot on goal. The acquisition device may be configured to acquire position data of the object as well as of at least one person on the playing field using the received images of the object. These embodiments allow for a classification of shots on goal from recorded sport games, or from broadcasted sport games. The acquisition device may be configured to receive the images from a video recording of a sport game or any other image source providing a set of time-ordered images from a sport game.

According to one embodiment, the system comprises at least one image capturing device configured to capture images of the object during ΔT_{P}. The acquisition device is configured to acquire the position data of the object using the captured images of the object. By providing the at least one image capturing device, the captured images may be analyzed by means of methods, such as image analysis or image processing, in order to acquire the position data of the object. This provides for a convenient and cost-efficient system since image capturing devices are inexpensive and easy to deploy.

According to one embodiment, the at least one image capturing device is configured to capture images of at least a part of the playing field at a distance from the playing field. For example, the at least one image capturing device may be at least one overhead image capturing device configured to capture top view images of said at least a part of the playing field. These arrangements allows for a reduced interference with the game, keeping the disturbance of the persons on the playing field small. A plurality of image capturing devices may be needed to cover the entire playing field.

According to one embodiment, the at least one image capturing device is arranged to be attached to the goalkeeper. The at least one image capturing device may be configured to capture images of the game, such that, in use, the device captures images substantially from the field of view of the goalkeeper. Moreover, the at least one image capturing device may be provided on a helmet carried by the goalkeeper or, alternatively, on a front side of the body of the goalkeeper.

According to one embodiment, the system comprises a radio frequency (RF) transmitter arranged to be attached to the object and at least one RF receiver configured to receive an RF signal from the RF transmitter. The acquisition device is configured to acquire the position data of the object using the RF signal. This embodiment allows for a precise and fast determination of the position data which is easily automat zed. The RF signal may be used to acquire position data of the object by means of triangulation, trilateration, multilateration, a probabilistic model or the like.

According to another embodiment, the system further comprises a gaze direction device configured to acquire data relating to a gaze direction of the goalkeeper during said time interval ΔT_{P}, wherein the processing device is further configured to estimate if the gaze direction corresponds to the position of the object throughout said time interval ΔT_{P} using the acquired position data and the acquired data relating to the gaze direction of the goalkeeper, and further configured to register the shot as the first type of shot at least on a condition that the gaze direction not corresponds to the position of the object throughout said time interval ΔT_{P}.

According to another embodiment, the system further comprises a gaze direction device configured to acquire data relating to a gaze direction of the goalkeeper during the time interval ΔT_{S}, wherein the processing device is further configured to estimate if the gaze direction corresponds to the position of the object throughout the time interval ΔT_{S} using the acquired position data and the acquired data relating to the gaze direction of the goalkeeper, and further configured to register the shot as the first type of shot at least on a condition that the gaze direction not corresponds to the position of the object throughout the time interval ΔT_{S}.

In this context, a gaze direction is meant a direction towards which at least one eye, or a part of the eye, is looking. For instance, the gaze direction may be determined by measuring the position and motion of at least one eye relative to the head. Optionally, a part of an eye, such as the center of its pupil, may be monitored to determine a gaze direction. For example, in so-called dark pupil tracking, a relationship between the pupil and a reflection from the cornea is computed to locate gaze within a scene. Alternatively, various gaze angles may be measured to determine the gaze direction.

By compiling the acquired position data of the object and the acquired data relating to the gaze direction of the goalkeeper it may be established whether the gaze of the goalkeeper is fixed on the object during the time interval ΔT_{P} or not. Likewise, it may be established whether the gaze of the goalkeeper is fixed on the object during the time interval ΔT_{S} or not.

By considering also the gaze direction of the goalkeeper a more accurate shot classification may be obtained compared to merely assuming that the presence of an unobstructed path between the goalkeeper and the object implies that the goalkeeper is actually looking at the object. Research in the field of interceptive sports has indicated that in order for an athlete to increase his/her chance to successfully intercept an object, such as a ball or a puck, he/she needs to perform a final fixation (sometimes referred to as the “quiet eye” phenomenon) on or near the object during a time interval of a sufficient length. The above-mentioned embodiment thus makes it possible to use these research results as a basis for classifying the type of shot.

According to one embodiment the processing device is configured to estimate if the gaze direction corresponds to the position of the object by determining if the gaze direction corresponds to an area proximate to the object; for example, in ice hockey where a stick is used to move the object during a game, a stick-object interface, or something similar, may be the area to be focused on.

According to one embodiment, the gaze direction device is arranged to be attached to the goalkeeper.

According to one embodiment, the gaze direction device is arranged to be mounted at a distance from the playing field. Thereby, the goalkeeper need less amount of extra equipment attached to her/him for measuring the gaze direction.

Optionally, the gaze direction device is a combination of an arrangement attached to the goalkeeper and an arrangement mounted at a distance from the playing field.

According to one embodiment, the gaze direction device is an image capturing apparatus arranged to monitor at least one eye of the goalkeeper. The image capturing apparatus may provide still pictures or moving images of analog or digital form which may be analyzed by using e.g. image analysis to determine the position, movement, etc. of at least one eye of the goalkeeper.

According to one embodiment, the gaze direction device is a laser-based gaze direction device arranged to monitor at least one eye of the goalkeeper.

According to one embodiment, the processing device is configured to register the shot on goal in response to detecting an accelerated motion of the object in a direction towards the goal. The processing device may detect an accelerated motion, for example, using the acquired position data. Optionally, the object may comprise a detector device configured to measure an acceleration of the object and further configured to transmit a detection signal to the acquisition device in response to detecting an acceleration, wherein the processing device is configured to register the shot on goal in response to receiving the detection signal.

According to one embodiment, the acquisition device is further configured to acquire position data of at least one person on the playing field during at least one of the time intervals ΔT_{P} and ΔT_{S}, wherein the processing device is further configured to process the acquired position data of the at least one person on the playing field and the acquired position data of the object to determine if an unobstructed path between the goalkeeper and the object is maintained throughout the respective time interval ΔT_{P} or ΔT_{S}. In one embodiment, this may be useful for determining the presence of a player between the goalkeeper and the object, a presence which temporarily might screen the field of view of the goalkeeper and thus make the shot more difficult to save.

According to one embodiment, the acquisition device comprises at least one image capturing device configured to capture images of the at least one person during ΔT_{P} and/or ΔT_{S}, wherein the acquisition device is configured to acquire the position data of the at least one person using the captured images of the at least one person.

According to one embodiment, the at least one image capturing device is configured to capture images of at least a part of the playing field at a distance from the playing field. According to one embodiment, the at least one image capturing device is arranged to be attached to the goalkeeper. The details and advantages discussed above in relation to the embodiments related to the acquisition device being configured to capture images of the object, apply correspondingly to the present embodiment.

According to one embodiment, the system further comprises at least one RF transmitter arranged to be attached to the at least one person. Furthermore, the system comprises at least one RF receiver configured to receive an RF signal from the at least one RF transmitter, wherein the acquisition device is configured to acquire the position data of the at least one person using the RF signal. The concept and the advantages of this embodiment are similar to the concept and the advantages in relation to the embodiment above comprising an RF transmitter arranged to be attached to the object. In particular, position data may be collected during ΔT_{P} as well as during ΔT_{S}.

According to one embodiment, the at least one person according to the above is a player. According to yet another embodiment, the player is a goalkeeper.

According to one embodiment, the processing device is further configured to: determine an object trajectory based on the position data of the object; determine a trajectory of the at least one person based on the position data of the at least one person; and register the shot as the first type of shot at least on a condition that the object trajectory and the trajectory of the at least one person corresponds to a predetermined pattern.

In an alternative embodiment, the processing device is further configured to determine the object trajectory and the trajectories of the at least one person during the time interval ΔT_{S}.

According to the above the system may automatically classify a shot based on trajectories of the object and the at least one person. In other words the system may identify a certain game scenario or movement pattern preceding the shot on goal and based thereon classify the shot.

According to one embodiment, the system further comprises a statistics collecting device configured to register a number of shots determined as the first type of shot by the processing device. Optionally the statistics collecting device may be configured to register a number of shots determined as the second type of shot by the processing device. This may be useful for extracting important information about situations relating to shots on goal during an extended amount of time, such as during a period, during a half, or during a total match time of a game. Moreover, the statistics collecting device may collect data during several, different games as well as during training.

According to one embodiment, a game may be analyzed according to the number of shots of the first and second type, respectively, during a fixed time interval, such as a period or a total play time of a game, thereby providing important game information which is inaccessible to the naked eye.

According to one embodiment, the system further comprises a display device configured to visually present the number of shots registered by the statistics collecting device. A visual or graphical presentation for presenting the collected data may assist e.g. a coach in analyzing situations relating to shots on goal in a game or during training, and assist players in improving their skills. The result of the analysis may be further passed on to other persons, such as the players in a team, or to other devices. Moreover, the graphical presentation may be useful in presenting detailed information about a game, e.g. via screens placed in an arena or via a television broadcast etc.

Other features and advantages of embodiments of the present invention will become apparent to those skilled in the art upon review of the following drawings, the detailed description, and the appended claims.

### BRIEF DESCRIPTION OF THE DRAWINGS

The above, as well as additional objects, features and advantages of the present inventive concept, will be better understood through the following illustrative and non-limiting detailed description of preferred embodiments of the present inventive concept, with reference to the appended drawings, where like reference numerals will be used for like elements, wherein:

FIG. 1 schematically illustrates a top view of a part of an ice hockey rink, and shows an embodiment of a system according to the present inventive concept.

FIG. 2 is a flow chart showing illustrating an embodiment of the system for determining a type of shot according to the present inventive concept.

FIG. 3 is a flow chart showing illustrating an embodiment of the system for determining a type of shot according to the present inventive concept.

FIG. 4a and FIG. 4b schematically illustrate two different playing situations before a shot on goal which may be analyzed according to the present inventive concept.

FIG. 5 schematically illustrates an alternative embodiment of the system comprising RF receivers and RF transmitters.

### DETAILED DESCRIPTION OF PREFERRED EMBODIMENTS

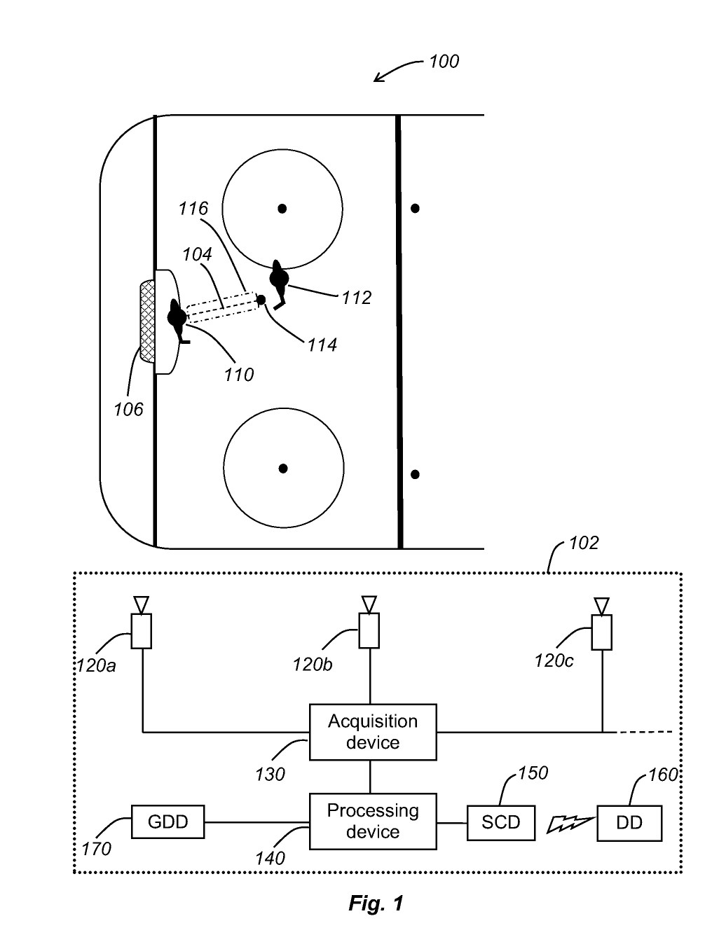

In the following, a first embodiment of a system 102 according to the present inventive concept will be described with reference to the schematic illustration of a part of a playing field 100 in FIG. 1. The embodiment will be described in connection with an ice hockey game. It should however be noted that the present inventive concept may be used in other sports than ice hockey. In fact, the system is generally applicable to any team sport involving a goalkeeper and an object which may be shot on a goal. Typical team sports include ice hockey, field hockey, roller hockey, bandy, soccer, team handball, water polo, lacrosse, other forms of hockey, football or the like wherein the object may be a spherical, cylindrical, or prolate spheroidal ball, a puck or the like.

With reference to FIG. 1, the system 102 is configured to acquire and process data pertaining to a shot of an object, in this case a puck 114 by means of a stick, on a goal 106 on an ice hockey rink 100.

According to the first embodiment, the system 102 comprises a plurality of image capturing devices 120a, 120b, 120c, . . . , an acquisition device 130 and a processing device 140, as illustrated in FIG. 1. The acquisition device 130 is configured to determine position data of the puck 114 as well as position data of the players 110, 112, wherein the player 110 is the goaltender 110, using images captured by the image capturing device 120a-c. Henceforth, the term “position data” is understood to mean position data of the puck 114 as well as position data of at least one player on the playing field unless otherwise is explicitly stated. Optionally, the system 102 may comprise an input device allowing an operator to control the parts of the system 102.

The image capturing devices 120a-c according to the first embodiment are placed at a distance from the playing field 100 and is fixedly arranged with respect to the playing field 100. According to an alternative embodiment, the image capturing devices 120a-c may be movably arranged with respect to the playing field 100, e.g. on movable camera stands. The image capturing devices 120a-c capture images covering a fixed, predetermined part of the playing field 100. The fixed, predetermined part of the playing field may correspond to the entire playing field including the goals and goaltenders of both teams, or only a portion of the playing field e.g. including only the goal and goaltender of one team, as is the case in FIG. 1. Each one of the image capturing devices 120a-c may capture images of a specific part of the playing field 100, thus giving rise to a set of captured images wherein images captured by two adjacent image capturing devices have overlapping portions or portions which border to each other.

It should be noted that the illustrated position of the system 102, generally, in relation to the playing field and the illustrated positions of the image capturing devices 120a-c, specifically, only is schematic and has been chosen to simplify understanding of the embodiment. For example, one or more of the image capturing devices 120a-c may be arranged to capture images representing side views of the playing field. One or more of the images capturing devices 120a-c may also be arranged to capture the images from an oblique angle. One or more of the images capturing devices 120a-c may also capture top view images of said at least a part of the playing field. Only three image capturing devices 120a-c are shown in FIG. 1; note, however, that there may be less than three image capturing devices or more image capturing devices.

The image capturing devices 120a-c according to the first embodiment capture images of the puck 114 and the persons on the playing field 100, such as the players 112, the goaltenders 110, the referee and the linesmen. Each image capturing device 120a-c may for example be a digital still-image camera, a digital video camera or the like. Alternatively, each image capturing device 120a-c may be an analog camera wherein the analog captured images may be digitized by a digitalization device.

Each image capturing devices 120a-c produces two-dimensional frames at a discrete collection of consecutive time instants. In more detail, digital images, or frames, are captured at each of the consecutive time instants Tₖ, for k=1, . . . . The time instants Tₖ may be distributed over the entire length of a game or only a part thereof, i.e. a period of a game. The pixel data of the digital images, such as the intensity and/or colors of the pixels, at a time instant t may be represented by a rectangular two-by-two matrix A(m,n; t) of positive numbers, where m=1, . . . ,M and n=1, . . . N. The number M×N represents the total number of pixels comprised in the frame. The pixel data of each frame for each time instant Tₖ, is provided to the acquisition device 130, preferably in a compressed form. More specifically, the pixel data may be labeled by the matrices Aᵢ(m,n; Tₖ), for k=1, . . . , where i=1, . . . ,C labels the different image capturing devices. In FIG. 1, the number C is 3, since there are three image capturing devices 120a-c.

If, as described above, a certain set of captured images have overlapping portions, the corresponding pixel data may be sent to the acquisition device 130 from one or, alternatively, from several of the image capturing devices. For example, if at a given time instant Tₖ, two matrices A₁(m,n; Tₖ) and A₂(m,n; Tₖ) substantially agree over a subset of values of m and n, either of them or both may be sent to the acquisition device 130.

The acquisition device 130 is configured to receive the sent pixel data of the frames from the image capturing devices 120a-c. The acquisition device 130 may be configured to combine the received pixel data into a single set of pixel data representing the part of the playing field 110 at a given time instant Tₖ as viewed by the image capturing devices 120a-c.

As will be described below, the set of pixel data may then be utilized for determining position data of the puck 114 and the players 110, 112 etc. at the time instances Tₖ, for k=1, . . . ,Q, i.e. during a time interval starting at a time instant T₁ preceding a shot on goal and extending to a time instant T_{Q}=T₁+ΔT_{P} of the shot on goal. Thus the position data may be determined for T₁ through T_{Q}. Thereafter, the acquisition device 130 may provide the position data to the processing device 140 for further processing as will be described in the below.

The time instant of the shot on goal T_{Q}=T₁+ΔT_{P} may be manually determined by an operator of the system. E.g. the operator may make a note of the time T_{Q} when a shot on goal occurs and request the acquisition device 130, using the input device, to utilize the pixel data collected between the time instants T₁ and T_{Q}. Alternatively, the acquisition device 130 may be configured to repeatedly determine position data of the puck 114 from the images delivered by the image capturing devices 120a-c (e.g. using one of the image analysis methods described in detail below) to automatically determine the time instant of a shot on goal T_{Q}. For example, the acquisition device may compare consecutive positions of the puck 114 using the position data to determine if the puck 114 performs an accelerated motion towards the position of the goal 106 exceeding a predetermined threshold acceleration. In response to such a determination, the acquisition device 130 may acquire position data of the puck 114 and any players 110, 112 utilizing the pixel data collected between the time instant T₁ and T_{Q}.

In more detail, the acquisition device 130 comprises software for processing the received pixel data and determining the position data during the time interval ΔT_{P}. For example, the acquisition device 130 may determine the coordinates of pixels representing the puck 114. This may be determined by identifying the pixels having a color value corresponding to the color of the puck. Additionally or alternatively, the puck 114 may be identified on the basis of its shape. According to a method which may be more reliable in some cases, the digital images may be partitioned by the acquisition device 140 into different image regions, such as a background, comprising e.g. the playing field 100, the arena, etc., and a foreground, comprising e.g. the puck 114, the players 110, 112 etc. The background is preferably predetermined by capturing images of the playing field 100 etc. without any object or persons on it, thus producing background pixel data. The background pixel data is then used as a reference for determining the foreground which contains pixel data which differs substantially from the background pixel data. The foreground may for example be determined by subtracting the background pixel data from the captured images. Thus, the processing device 140 may determine whether a pixel represents a part of the background or whether it represents a part of the puck 114, the players 110, 112 etc.

According to one example, the coordinates of the pixels identified as representing the puck 114 and the players 110, 112 may be determined as the position data of the puck 114 and the players 110, 112. Accordingly, the position data of the puck 114 may include the coordinates of one or more of the pixels representing the puck 114. The one or more pixels may be any subset of the set of pixels representing the puck 114. For example, the one or more pixels may be the center pixel of the set of pixels representing the puck 114. Correspondingly, the position data of a player, e.g. player 110 or 112, may include the coordinates of one or more of the pixels representing the player, e.g. 110 or 112. The pixel coordinates may describe the row and the column of the pixel within the pixel set representing the playing field. This example may be advantageously used if used with the image capturing devices 120a-c capturing top view images of the playing field 100 since pixel coordinates then present a relatively simple mapping to the real-world coordinates.

In a more complex case, e.g. wherein the image capturing devices 120a-c capture side view images of the playing field 100, it may be advantageous to translate the coordinates of the pixels representing the puck 114 and the players 110, 112 to another coordinate system. For example by using a suitable mapping, the coordinates of the pixels may be translated into coordinates (preferably two-dimensional) representing the positions of the puck 114 and the players 110, 112 on the playing field 100 in relation to a predetermined reference point on the playing field 100. The reference point may e.g. be chosen as the center or face-off point of the playing field 100 or the goal 106. Accordingly, the position data of the puck 114 represents the position of the puck 114 in relation to a reference point on the playing field 100. Correspondingly, the position data of a player, e.g. the players 110, 112 represent the position of a player, e.g. the players 110, 112, in relation to a reference point on the playing field 100. The position may be described e.g. with Cartesian coordinates or polar coordinates.

In any case, the position data of the puck 114 or a player 110, 112 at a time instant Tₖ may include a position vector which (using Cartesian coordinates) may take the form X(Tₖ)=(X(Tₖ),Y(Tₖ)), The position data of the goaltender 110, the player 112 and the puck 114 at the time instant Tₖ between T₁ and T_{Q} may thus be represented by the position vectors X₁₁₀(Tₖ), X₁₁₂(Tₖ) and X₁₁₄(Tₖ), for k=1, . . . ,Q.

The processing device 140 receives from the acquisition device 130 the acquired position data between T₁ and T_{Q} for each one of the goaltender 110, the player 112 and the puck 114. The processing device 140 comprises a processor for processing the acquired position data. The processor may be e.g. a microprocessor, a central processor unit (CPU), or the like. The processor may be configured to execute software instructions to analyze the acquired position data according to the present inventive concept to estimate if an unobstructed path between the goalkeeper and the object exists and is maintained between T₁ and T_{Q}. The analysis performed by the processing device 140 may be performed in real time or, optionally, in a time-delayed fashion.

More specifically, according to the first embodiment, from the acquired position vectors X₁₁₀(Tₖ)=(X₁₁₀(Tₖ), Y₁₁₀(Tₖ))and X₁₁₄(Tₖ)=(X₁₁₄(Tₖ), Y₁₁₄(Tₖ)), the processing device 140 is configured to determine a straight path Pₖ (illustrated by reference numeral 104 in FIG. 1) between the goaltender 110 and the puck 114 for each time instant Tₖ, k=1, . . . ,Q. The straight path at the time instant Tₖ may be described by the vector

X₁₁₀(Tₖ)+(X₁₁₄(Tₖ)−X₁₁₀(Tₖ))σ,

where σ is real parameter between 0 and 1. The length and orientation of the straight paths Pₖ 104 may change with time.

The processing device 140 is further configured to determine if the straight path 104 between the goaltender 110 and the puck 114 was unobstructed throughout ΔT_{P}. In other words, the processing device 140 is configured to determine if the path was broken sometime instant during ΔT_{P}. The straight path Pₖ 104 may be determined to be broken during ΔT_{P} if, at least at one time instant Tₖ, k=1, . . . ,Q, there was at least one player or other object crossing the straight path Pₖ 104. The presence of the at least one player is determined from the acquired position vectors, which in the first embodiment is given by X₁₁₂(Tₖ).

There are alternative ways to determine if the straight path 104 between the goaltender 110 and the puck 114 was unobstructed or obstructed. For example, one may define zones Aₖ 116 surrounding the straight paths Pₖ 104 for k=1, . . . ,Q. The zones Aₖ 116 preferably have a fixed, predetermined form and size and are centered on Pₖ 104. Since the length and the orientation of the straight paths Pₖ 104 may change with time, also the orientation of the zones Aₖ may change with time. In this example, the path between the goaltender 110 and the puck 114 is determined to be broken during ΔT_{P} if, at least at one time instant Tₖ, k=1, . . . ,Q, there was at least one player (or other object) present in the zone Aₖ 116.

The processing device 140 is configured to register the shot on goal as a first type of shot on a condition that an unobstructed path between the goalkeeper and the object not was maintained throughout the time interval ΔT_{P}. If, on the other hand, an unobstructed path between the goalkeeper and the object was maintained throughout the time interval ΔT_{P} the shot on goal may be registered as a second type of shot. Each registered shots may be stored in a memory comprised in the processing device 140. The memory may for example be a volatile memory, such as a Random Access Memory (RAM), a flash memory, or similarly.

According to the first embodiment of the invention, the time interval ΔT_{P} preceding the shot on goal is a predetermined time interval. ΔT_{P} may correspond to a time interval which is considered to be of sufficient length for the goaltender 110 to prepare for the shot. This value may be different for different goaltenders and may hence advantageously be calibrated for each goaltender. In some cases a sufficient time may be a value between 10 ms and 750 ms, between 75 ms and 125 ms or 100 ms. These intervals may result in more accurate shot classifications since they correspond to the minimum quiet eye durations indicated in the above-mentioned research.

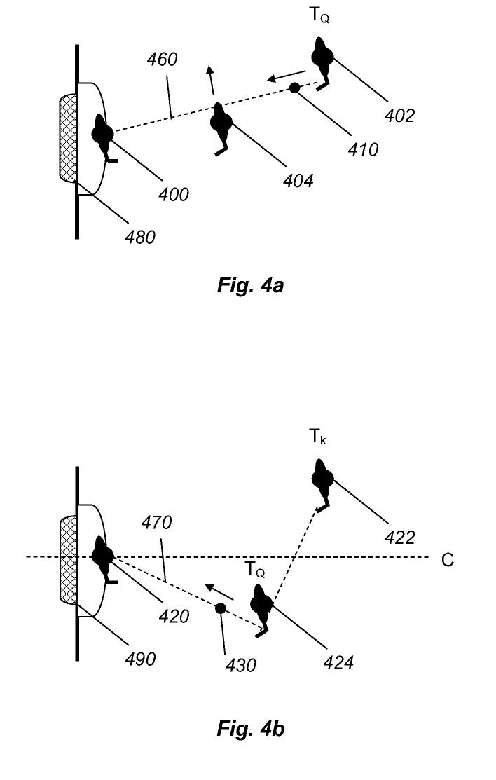

FIG. 4a illustrates a situation wherein the shot on goal will be registered as a first, i.e. more difficult, type of shot. A puck 410 is shot on the goal 480 at a time instant T_{Q} in the direction as indicated by the arrow by a player 402. However, sometime during the time interval ΔT_{P} immediately preceding the shot on goal, a player 404 obstructs the path 460 between the goaltender 400 and the object 410. This may result in the goaltender 400 losing focus on the object 410 and require him to regain focus on the object 410. However, since the shot occurs at time instant T_{Q} the available time to do so is insufficient. It will therefore be difficult for the goaltender 400 to sufficiently prepare for the shot. This qualifies the shot as a first, i.e. more difficult, type of shot.

Optionally, the system 102 may further comprise a statistics collecting device 150 and a display device 160. According to this option, the output from the processing device 140 is sent to the statistics collecting device 150, wherein all the previous output from the processing device 140 also has been collected. The collected statistics is thereafter sent to the display device 160 for presenting data about the first and second type of shots visually on a screen. The statistics collecting device 150 may be configured to conduct wireless communication with the display device 160, as represented by the flash. The display device 160 may be a smart phone. Optionally, the display device 160 may be another type of user equipment (UE) such as a mobile telephone, a laptop computer, etc. Alternatively the statistics collecting device 350 may be in wired communication with the display device 160 wherein the display device 160 may be e.g. a TV screen or some other screen for presenting static or moving graphical data.

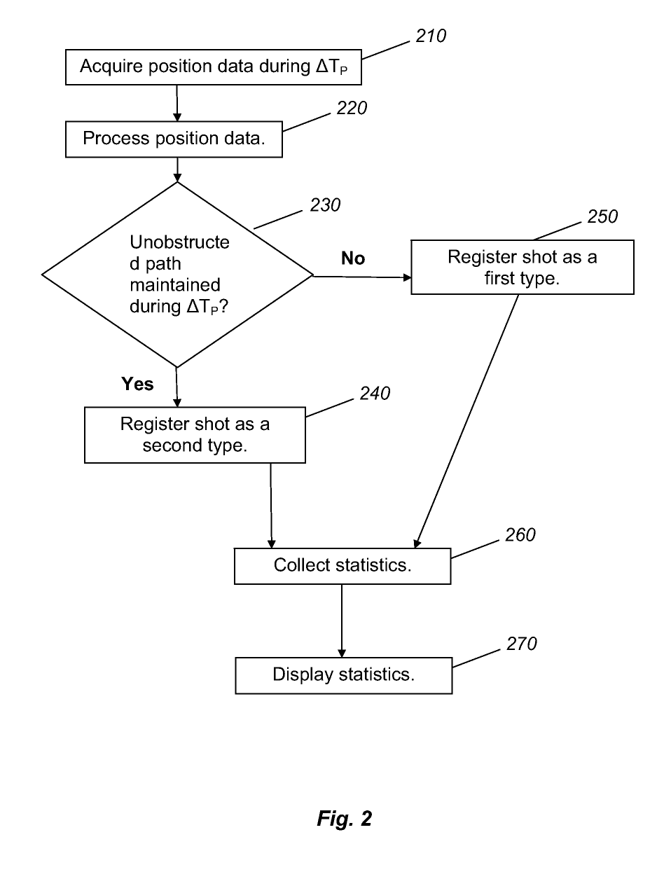

In the following, the operations performed by the system 102 will be described with reference to the flow chart in FIG. 2 which illustrates the operations performed by the acquisition device 130, the processing device 140, the statistics collecting device 150 and the display device 160.

As described in detail in the above, according to the first embodiment, the acquisition device 130 acquires position data during a time interval ΔT_{P} preceding the shot on goal (box 210). The position data is thereafter processed by the processing device (box 220) to estimate whether an unobstructed path between the goalkeeper and the object was maintained throughout the time interval ΔT_{P} or not (box 230). If an unobstructed path not was maintained, the shot is registered by the processing device 140 as a first type of shot (box 250), and if the unobstructed path was maintained, the shot is registered as a second type of shot (box 240). The data about the first and second type of shots may thereafter be collected (box 260) by the statistics collecting device 150 and displayed (box 260) by means of a display device 160 which was described above.

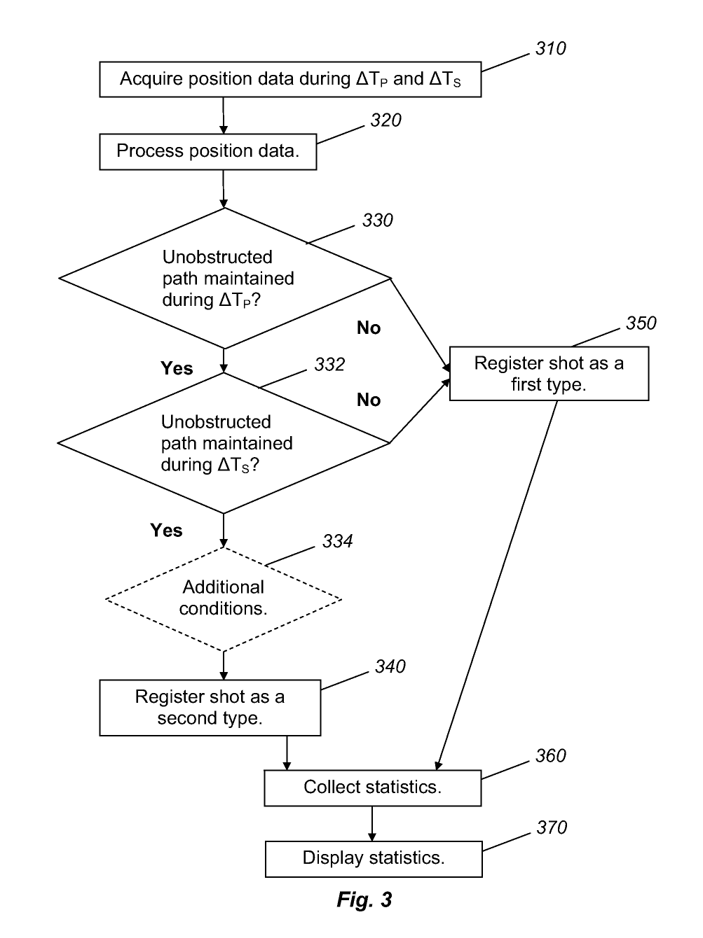

With reference to FIGS. 1 and 3, a variant of the system 102 configured to evaluate further optional conditions will be described.

The acquisition device 130 acquires position data during the time interval ΔT_{P} preceding the shot on goal, as in the first embodiment above, and in addition acquires position data during a time interval ΔT_{S} succeeding the shot on goal. ΔT_{P} and ΔT_{S} are predetermined time intervals. In line with the above discussion ΔT_{P} and ΔT_{S} may be set to values between 10 ms and 750 ms, between 75 ms and 125 ms or to the value 100 ms. The predetermined values of ΔT_{P} and ΔT_{S} may be the same or may be different.

Position data of the puck 114 is acquired by the acquisition device 130 during ΔT_{P} preceding the shot on goal as well as during ΔT_{S} succeeding the shot on goal (box 310). The position data is acquired in a manner analogously to the first embodiment of the invention described above. The position data of the two kinds is thereafter processed (box 320) by the processing device 140 to estimate if an unobstructed path between the goalkeeper 110 and the puck 114 was maintained throughout the time interval ΔT_{P} or not (box 330). If the unobstructed path was not maintained, the shot is registered by the processing device 140 as a first type of shot (box 350).

On the other hand, if the unobstructed path was maintained during ΔT_{P}, there is a further analysis performed by the processing device 140 (box 332) of the position data acquired during the time interval ΔT_{S}. If the unobstructed path was not maintained during ΔT_{S}, the shot is registered as the first type of shot (box 350). If on the other hand the unobstructed path was maintained also during ΔT_{S}, the shot is registered as a second type of shot (box 340) by the processing device 140.

As described above, the data about the first type of shots and the second type of shots may thereafter be collected (box 360) by the statistics collecting device 150 and displayed (box 370) by means of the display device 160.

As indicated in FIG. 3, the system 102 may be configured to evaluate even further optional conditions (box 334).

As a first additional condition, the processing device 140 may be configured to determine a direction of the puck 114 during the time interval ΔT_{S}, and register the shot on goal as the first type of shot on a condition that the direction of the object was changed sometime during said time interval ΔT_{S}. A changed direction may e.g. be determined by comparing position data representing consecutive positions of the puck 114. More specifically, the processing device 140 may determine a translation vector for the puck 114 by subtracting a position first position vector X₁₁₄(Tₖ) from a second subsequent position vector X₁₁₄(Tₖ₊₁) and based on the translation vector estimate a position of the puck 114 for a time instant Tₖ₊₂. If acquired position (i.e. X₁₁₄(Tₖ₊₂)) differs from the estimated position by more than predetermined amount, it may be determined that the puck 114 has changed direction.

A changed direction may e.g. be the result of a deflection of the puck 114 by another player than the shooter. Such a deflection may cause the goaltender 110 to lose focus on the puck 114 and/or force him to reconsider the expected path of the puck 114. Such a situation may make the shot more difficult for the goaltender 110 to save and may thus qualify the shot to be registered as the first type of shot.

As a second additional condition, the processing device 140 may be configured to determine if the puck 114 during the time interval ΔT_{P} has crossed a geometrical line extending longitudinally on the playing field in front of the goal, and register the shot on goal as the first type of shot at least on a condition that the object has crossed the geometrical line during the time interval ΔT_{P}. Such a situation is illustrated in FIG. 4b wherein the shot on goal at time instant T_{Q} by a player 424 is preceded by a pass from a player 422 at time instant Tₖ to the player 424. Tₖ is a time instant within the time interval ΔT_{P} which is ended by the time instant of the shot T_{Q}. During its movement towards the player 424, the puck 430 crosses the central line C. This may require the goaltender 420 to change the position of her/his head and her/his body, which may result in the goaltender loosing track of the puck 430 or at least make it more difficult for the goaltender 420 to prepare and get in position for the shot. Such a situation may make the shot more difficult for the goaltender 420 to save and may thus qualify the shot to be registered as the first type of shot.

As a third additional condition, the processing device 140 may be configured to determine a puck trajectory 114 using the position data of the object. The processing device 140 may further determine a trajectory of at least one player (e.g. player 112) based on the position data of the player 112. The processing device 140 may determine whether the determined trajectories correspond to a predetermined pattern. Such a pattern may e.g. correspond to a movement pattern occurring during a certain offensive or defensive strategy. The predetermined pattern may be established from a plurality of sets of training data which have been collected e.g. during practice. The processing device 140 may be configured to register the shot as second type on a condition that the trajectories correspond to the predetermined pattern, e.g. using pattern recognition algorithms.

Should neither the condition of the first example nor the condition of the second example be fulfilled, the shot may be considered to be a comparably simple shot and thus qualify to be registered as the second type of shot (box 340).

The steps in FIG. 3 have been described in a particular order. Note, however, that in alternative embodiments, the order in which the steps are performed may be different.

Optionally, the processing device 140 may be configured to register a shot as a further type of shot in accordance with the actual condition being fulfilled. More specifically, the processing device 140 may register the shot as a third type of shot if the above-mentioned first additional condition is fulfilled, as a fourth type of shot if the above-mentioned second additional condition is fulfilled, and as a fifth type of shot if the above-mentioned third additional condition is fulfilled. The third, fourth and fifth types may be regarded as specific subtypes of the first type of shot, i.e as subtypes of shots which are comparably difficult to save.

In the preceding embodiments, the classification has relied on the simplifying assumption that as long as an unobstructed path is maintained between the goaltender and the object throughout ΔT_{P}, the shot may be considered as a comparably simple shot. The underlying assumption used is thus that the goaltender actually is looking in the general direction of the puck. According to a more detailed second embodiment, the system does not rely on this simplifying assumption but also considers the actual gaze direction of the goaltender.

More specifically, the system further comprises a gaze direction device indicated by reference numeral 170 in FIG. 1. The gaze direction device 170 is in communication with the processing device 140 and is configured to determine a gaze direction of the goaltender 110. The gaze direction device 170 acquires gaze direction data relating to the position, movement etc. of one eye of the goaltender 110. As described below, the gaze direction device 170 also determines the head movement of the goaltender 110.

The gaze direction device 170 may be provided on a helmet carried by the goaltender 110. Alternatively, the gaze direction device may be provided on the goaltender using e.g. a headband, a pair of glasses, contact lenses, a bite bar, a forehead support, or something similar.

The gaze direction device 170 comprises a light source for illuminating the eye, a first digital camera capturing digital images of the pupil, the iris and the cornea. Moreover, the gaze direction device 170 comprises a second digital camera provided on the helmet capturing images substantially corresponding to the field of view of the goaltender 110 for determining the orientation of the head of the goaltender 110.

The first as well as the second digital camera capture images at least between T₁ and T_{Q,} i.e. for each of the time instances Tₖ, k=1, . . . ,Q described above, and produce pixel data associated to each image. The pixel data, which thus is data relating to a gaze direction of the goaltender 110, is sent to the processing device 140, which according to the second embodiment is configured to execute software instructions to analyze the position data of the goaltender X_{110,} the position of the eye and the orientation of the head to estimate if an unobstructed path between the goalkeeper and the object was maintained throughout the time interval ΔT_{P}.

More specifically, the images from the first digital camera provide the processing device with pixel data for determining the movement of the pupil relative to a predetermined reference position of the pupil. In the images, the pupil may be identified as a set of pixels being darker than surrounding pixels.

The images from the second digital camera provide the processing device 140 with pixel data for determining the orientation of the head of the goaltender 110. The processing device 140 may then determine position of the puck 114 within each image captured by the second digital camera. Thus, for a given time instant Tₖ the processing device 140 may determine whether the eye of the goaltender 140 is looking at the puck 114 using the position of the puck 114 within the image captured by the second digital camera and position of the pupil within the image captured by the first digital camera, and thus estimate whether the gaze direction corresponds with the position of the puck 114.

The processing device 140 may be configured to determine the gaze direction to correspond to the position of the puck 114 if the gaze direction falls within a degrees of the visual angle, where the visual angle is the angle the object subtends at the eye. For example, α may be between 0.5 and 8 degrees, more preferably a may be a value between 2 and 4 degrees, and most preferably a value of 3 degrees. This wider understanding of the term “focusing” corresponds to the results of the above-mentioned research relating to the quiet eye phenomenon. It takes into account the trajectory and motion of the object, as well as the line of sight, being non-ideal; for example, the object may to wobble, spin etc.

The processing device 140 may register the shot as the first type of shot at least on a condition that the gaze direction not corresponds to the position of the object for at least one time instant Tₖ during ΔT_{P}.

Gaze directions devices similar to the gaze direction device 170 are known in the art. One such example which may be used to determine the gaze direction is the mobile corneal reflection system (Model ASL Mobile Eye II) which may be obtained from Applied Science Laboratories, 175 Middlesex Turnpike, Bedford, Mass. 01730 USA.

According to an alternative to the second embodiment, the gaze direction device may comprise a search coil provided in e.g. a contact lens. By generating alternating magnetic fields by magnets positioned around the eye, the position of the eye may be determined by means of electromagnetic induction.

According to a third embodiment, a gaze direction device may be provided instead of the image acquisition devices 120a-c. According to this third embodiment, the gaze direction device 170 is provided on a helmet carried by the goaltender 110 and includes a digital camera capturing images in the direction the head of the goaltender 110 is turned. Analogously to the image capturing devices 120a-c, the digital camera capture images between T and T+ΔT_{P}, i.e. for each of the time instances Tₖ, k=1, . . . ,Q described above, and produce associated pixel data. The pixel data is sent to the acquisition device 140 which analyzes the pixel data to determine the position of the puck 114 within each captured image. The acquired position data thus represents the pixel coordinates of the puck 114 within each captured image. If no puck 114 is found in a captured image, this indicates that the path between the goaltender 110 and the puck 114 was obstructed at this time instant. The acquisition device 130 provides the acquired position data to the processing device 140 which analyzes the position data for each captured image to determine whether the puck 114 is within a predetermined region of each captured image. The predetermined region may represent e.g. a central area within an image. If the puck 114 is visible within the predetermined region in each image captured throughout the time interval ΔT_{P}, it may be assumed that the goaltender 110 has had sufficient time to focus on the object and thus prepare for the shot, otherwise the shot may be registered as a first type of shot.

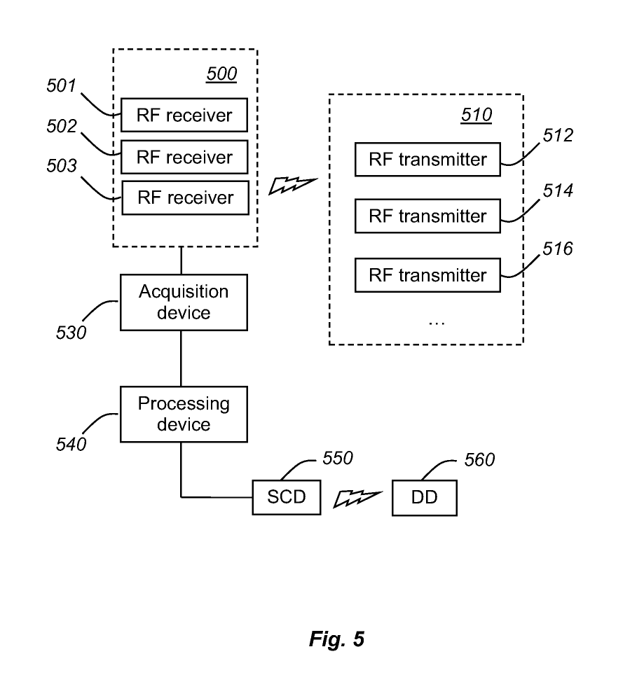

According to a fourth embodiment, there is provided a system not relying on image analysis but rather comprises RF devices, such as RF transmitters and RF receivers or, alternatively RF transceivers, in order to acquire position data of the puck and the persons on the playing field. Next, a schematic illustration of the fourth embodiment, implemented in relation to a hockey rink, will be described with reference to FIG. 5.

The fourth embodiment, illustrated in FIG. 5, comprises an RF receiver arrangement 500, a RF transmitter arrangement 510, an acquisition device 530, a processing device 540, a statistics collecting device 550 and a display device 560.

The RF transmitter arrangement 510 comprises several RF transmitters 512, 514, 516, . . . which are configured to send RF signals to be received by the RF receiver arrangement 500. The RF transmitter 512 may be attached to the puck, the RF transmitter 514 may be attached to a player and the RF transmitter 516 may be attached to the goaltender. Optionally, referees, linesmen, and the like, may also carry RF. In more detail, each of the RF transmitters 512, 514, 516, . . . may comprise an active RF tag or some other type of tag, such as a battery assisted passive (BAP) tag etc. The RF transmitters 512, 514, 516, . . . are arranged to send RF signals periodically at a fixed frequency f.

The RF receiver arrangement 500 comprises a plurality of RF receiver units 501, 502, 503. In FIG. 5, only three RF receiver units 501, 502 and 503 are shown however, the RF receiver arrangement 500 may include more or less receiver units. The RF receiver units 501, 502, 503 are may be arranged at positions at the hockey rink. An RF signal transmitted from one RF transmitter, say 512, may thus be received by the different RF receiver units 501, 502 and 503 at different time instances. From this time difference of arrival, the position of the RF transmitter 512, and hence the puck, may be determined e.g. using called multilateration, or hyperbolic positioning. Optionally, other methods for determining position data may be used, such as triangulation using the signal strengths of the signal as received at each RF receiver unit 501, 502, 503.

The RF transmitters 512, 514, 516, . . . transmit RF signals to the RF receiver 500 with a frequency F, the position data of the RF transmitters 512, 514, 516, . . . , the acquisition device 530 may determine the positions of the puck, the player and the goaltender during a time interval ΔT_{P} before a shot on goal. More precisely, the position data is acquired at consecutive time instances Tₖ throughout ΔT_{P}. The processing device 140 may then proceed in analogy with the description of e.g. the first embodiment wherein reference is being made to the previous discussion. This applies also to the characteristics of the fourth embodiment illustrated, other than those associated to the acquiring of position data.

According to an additional embodiment, the system comprises a combination of image capturing devices 120 and RF devices 500, 510 in order to acquire position data.

According to an additional embodiment, the subsystem, comprising the RF transmitter device 510 and the RF receiver 500, may be a real-time locating system (RTLS) or an Indoor Positioning System (IPS) for determining the position of the puck and the persons, on the playing field.

According to even further embodiments, the position data may be determined by a non-cooperative scanning process, using technologies such as Radio Detection and Ranging (RADAR) or Laser Detection and Ranging (LADAR). According to another embodiment, the position may be determined by means of infrared or ultrasonic ranging.

1. A system for acquiring and processing data pertaining to a shot of an object, such as a puck or a ball, on a goal on a playing field, said goal being guarded by a goalkeeper, the system comprising:
an acquisition device configured to acquire position data of the object during a time interval ΔT_{P} preceding the shot on goal, and
a processing device configured to process the acquired position data of the object to estimate if an unobstructed path between the goalkeeper and the object is maintained throughout said time interval ΔT_{P}, and configured to register the shot on goal as a first type of shot at least on a condition that an unobstructed path between the goalkeeper and the object not was maintained throughout said time interval ΔT_{P}.

2. A system according to claim 1, wherein the acquisition device is further configured to acquire position data of the object during a time interval ΔT_{S} succeeding the shot on goal, and wherein the processing device is further configured to determine if an unobstructed path between the goalkeeper and the object is maintained during said time interval ΔT_{S}, and configured to register the shot on goal as the first type of shot at least on a condition that an unobstructed path between the goalkeeper and the object not was maintained throughout said time interval ΔT_{S}.

3. A system according to claim 2, wherein the processing device is further configured to process the acquired position data of the object during said time interval ΔT_{S} to determine a direction of the object during said time interval ΔT_{S}, and configured to register the shot on goal as the first type of shot at least on a condition that said direction of the object was changed sometime during said time interval ΔT_{S}.

4. A system according to claim 1, wherein the processing device is further configured to process the acquired position data of the object to determine if the object during the time interval ΔT_{P} has crossed a geometrical line extending longitudinally on the playing field in front of the goal, and wherein the processing device is configured to register the shot on goal as the first type of shot at least on a condition that the object has crossed the geometrical line during said time interval ΔT_{P}.

5. A system according to any of claims 1-4, wherein the processing device is further configured to register the shot on goal as a second type of shot on a condition that an unobstructed path between the goalkeeper and the object is maintained throughout said time interval ΔT_{P} and none of the conditions of claims 1-4 are fulfilled.

6. A system according to claim 1, further comprising at least one image capturing device configured to capture images of the object during ΔT_{P}, wherein the acquisition device is configured to acquire said position data of the object using the captured images of the object.

7. A system according to claim 6, wherein the at least one image capturing device is configured to capture images of at least a part of the playing field at a distance from the playing field.

8. A system according to claim 6, wherein the at least one image capturing device is arranged to be attached to the goalkeeper.

9. A system according to claim 1, further comprising a radio frequency (RF) transmitter arranged to be attached to the object and the system further comprising at least one RF receiver configured to receive an RF signal from the RF transmitter, wherein the acquisition device is configured to acquire said position data of the object using said RF signal.

10. A system according to claim 1, further comprising a gaze direction device configured to acquire data relating to a gaze direction of the goalkeeper during said time interval ΔT_{P}, wherein the processing device is further configured to estimate if the gaze direction corresponds to the position of the object throughout said time interval ΔT_{P} using said acquired position data and said acquired data relating to the gaze direction of the goalkeeper, and further configured to register the shot as the first type of shot at least on a condition that the gaze direction not corresponds to the position of the object throughout said time interval ΔT_{P}.

11. A system according to claim 10, wherein the gaze direction device is arranged to be attached to the goalkeeper.

12. A system according to claim 10, wherein the gaze direction device is arranged to be mounted at a distance from the playing field.

13. A system according to claim 11 or 12, wherein the gaze direction device is a camera device arranged to monitor at least one eye of the goalkeeper.

14. A system according to claim 11 or 12, wherein the gaze direction device is a laser-based gaze direction device arranged to monitor at least one eye of the goalkeeper.

15. A system according to claim 1, wherein said processing device is configured to register the shot on goal in response to detecting an accelerated motion of the object in a direction towards the goal.

16. A system according to claim 1, wherein said acquisition device is further configured to acquire position data of at least one person on the playing field during said time interval ΔT_{P}, wherein the processing device is further configured to process the acquired position data of the at least one person on the playing field and the acquired position data of the object to determine if an unobstructed path between the goalkeeper and the object is maintained throughout said time interval ΔT_{P}.

17. A system according to claim 16, further comprising at least one image capturing device configured to capture images of the at least one person during ΔT_{P}, wherein the acquisition device is configured to acquire said position data of the at least one person using the captured images of the at least one person.

18. A system according to claim 17, wherein the at least one image capturing device is configured to capture images of at least a part of the playing field at a distance from the playing field.

19. A system according to claim 17, wherein the at least one image capturing device is arranged to be attached to the goalkeeper.

20. A system according to claim 16, comprising at least one RF transmitter arranged to be attached to the at least one person and the system further comprising at least one RF receiver configured to receive an RF signal from the at least one RF transmitter, wherein the acquisition device is configured to acquire said position data of the at least one person using said RF signal.

21. A system according to any one of claims 16-20, wherein the at least one person is a player.

22. A system according to claim 21, wherein said player is the goalkeeper.

23. A system according to claim 16, wherein said processing device is further configured to determine an object trajectory based on said position data of the object; determine a trajectory of the at least one person based on said position data of the at least one person; and register the shot as the first type of shot at least on a condition that said object trajectory and said trajectory of the at least one person corresponds to a predetermined pattern.
